(19) United States
(12) Patent Application Publication
(10) Pub. No.: US 2019/0317427 A1
(43) Pub. Date: Oct. 17, 2019

(54) RESIN COMPOSITION AND RESIN MOLDED ARTICLE

(71) Applicant: CANON KABUSHIKI KAISHA, Tokyo (JP)

(72) Inventor: Akira Yane, Tokyo (JP)

(21) Appl. No.: 16/447,826

(22) Filed: Jun. 20, 2019

Related U.S. Application Data
(63) Continuation of application No. PCT/JP2017/043923, filed on Dec. 7, 2017.

(30) Foreign Application Priority Data
Dec. 26, 2016 (JP) 2016-251371
Dec. 4, 2017 (JP) 2017-232343

(51) Int. Cl. G03G 15/08; B29B 7/90; B29C 48/00; B29C 45/00; G03G 15/00; C08F 210/02; C08F 216/06; C08F 110/02; C08K 3/04; C08K 7/06; C08K 9/04

(52) U.S. Cl. CPC G03G 15/0865; B29B 7/905; B29C 48/022; B29C 45/0001; G03G 15/556; B29K 2101/12; C08F 216/06; C08F 110/02; C08K 3/04; C08K 7/06; C08K 9/04; C08F 210/02

(57) ABSTRACT

Provided is a resin composition having high conductivity without blending a high concentration of carbon fibers. The resin composition includes a thermoplastic resin, carbon black, and carbon fibers coated with a conductive liquid, wherein a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less.

### CROSS-REFERENCE TO RELATED APPLICATIONS

This application is a Continuation of International Patent Application No. PCT/JP2017/043923, filed Dec. 7, 2017, which claims the benefit of Japanese Patent Application No. 2016-251371, filed Dec. 26, 2016, and Japanese Patent Application No. 2017-232343, filed Dec. 4, 2017, all of which are hereby incorporated by reference herein in their entirety.

### BACKGROUND OF THE INVENTION

### Field of the Invention

The present invention relates to a resin composition and a resin molded article each of which is useful, as a conductor utilizing high conductivity, for a conductive member of any of various electronic and electrical devices, such as a laser printer, a digital single-lens reflex camera, a compact digital camera, a smartphone, and a personal computer.

### Description of the Related Art

A conductive resin molded article has high conductivity, and hence is widely used as an alternative material to a metal to serve as a conductive member of, for example, a digital single-lens reflex camera, a compact digital camera, a smartphone, or a personal computer.

As an example of the conductive resin molded article, in Japanese Patent Application Laid-Open No. 2015-34984, there is a description that a conductive resin sheet obtained by mixing an EVA resin with carbon black is used as a capacitance-detecting member of a laser printer.

In addition, in Japanese Patent Application Laid-Open No. 2012-229345, there is a description that a thermoplastic resin is mixed with carbon fibers, metal fibers, and the like to have high conductivity, and the resultant is used as an electromagnetic wave-shielding member.

As described above, a resin molded article having high conductivity has been achieved by mixing a resin with a filler having high conductivity, such as carbon black, carbon fibers, and metal fibers.

However, although a molded product having high conductivity can be obtained by using a small amount of the metal fibers, the metal fibers are not excellent in surface properties of the molded product because of markedly poor adhesiveness between each of the fibers and the resin. In addition, according to results of an investigation made by the present inventor, the carbon fibers and the carbon black each have lower conductivity than the metal fibers, and hence, in order to obtain high conductivity, the carbon fibers and the carbon black need to be blended in large amounts of generally 10 mass % or more and 35 mass % or more, respectively, into the resin molded article. However, it has been found that, also when the carbon fibers and the carbon black are blended in large amounts into the molded product, the surface properties of the molded product become poor. When the surface properties are poor, in the case of, for example, integrally molding an insulating resin member, such as a housing, and a conductive member, such as wiring, air at a resin interface is not completely eliminated, sometimes leading to occurrence of separation, peeling, or the like.

Therefore, an object of the present invention is to provide a resin composition capable of achieving high conductivity and high surface properties in a molded resin by blending relatively small amounts of carbon fibers and carbon black, and a method of producing the resin composition.

### SUMMARY OF THE INVENTION

The present invention relates to a resin composition including: a thermoplastic resin; carbon black; and carbon fibers coated with a conductive liquid, wherein a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less.

The present invention also relates to a method of producing a resin molded article, the method including the following steps (a), (b), and (c): (a) preparing carbon fibers coated with a conductive liquid by coating the carbon fibers with the conductive liquid; (b) producing a composited resin composition by blending a thermoplastic resin, carbon black, and the carbon fibers coated with a conductive liquid prepared in the step (a) at such a ratio that a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less; and (c) subjecting the resin composition composited in the step (b) to extrusion molding.

The present invention also relates to a method of producing a resin molded article, the method including the following steps (a), (b), and (d): (a) preparing carbon fibers coated with a conductive liquid by coating the carbon fibers with the conductive liquid; (b) producing a composited resin composition by blending a thermoplastic resin, carbon black, and the carbon fibers coated with a conductive liquid prepared in the step (a) at such a ratio that a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less; and (d) subjecting the resin composition composited in the step (b) to injection molding.

The present invention also relates to a resin molded article produced by molding a resin composition including: a thermoplastic resin; carbon black; and carbon fibers coated with a conductive liquid, wherein a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less.

Further features of the present invention will become apparent from the following description of exemplary embodiments with reference to the attached drawings.

### BRIEF DESCRIPTION OF THE DRAWINGS

FIG. 1 is a view for schematically illustrating a resin molded article containing carbon fibers, carbon black, and a thermoplastic resin in the case where the amount of the carbon fibers is small.

FIG. 2 is a view for schematically illustrating a resin molded article containing carbon fibers, carbon black, and a thermoplastic resin in the case where the amount of the carbon fibers is large.

FIG. 3 is a view for schematically illustrating a conductive path in a resin molded article containing carbon fibers, carbon black, and a thermoplastic resin.

FIG. 4 is a view for schematically illustrating a conductive path in a resin molded article containing carbon fibers coated with a conductive liquid, carbon black, and a thermoplastic resin.

FIG. 5 is a cross-sectional schematic view for illustrating a cartridge according to one embodiment of the present invention.

FIG. 6 is a schematic view for illustrating an image-forming apparatus according to one embodiment of the present invention.

### DESCRIPTION OF THE EMBODIMENTS

A resin composition of the present invention includes a thermoplastic resin, carbon black, and carbon fibers coated with a conductive liquid, wherein the content of the thermoplastic resin is 65 mass % or more and 94.9 mass % or less, the content of the carbon black is 5.0 mass % or more and 30 mass % or less, and the content of the carbon fibers coated with a conductive liquid is 0.1 mass % or more and 5.0 mass % or less. Thus, a resin composition having high conductivity despite the small contents of the carbon fibers and the carbon black can be achieved.

The present invention is described below.

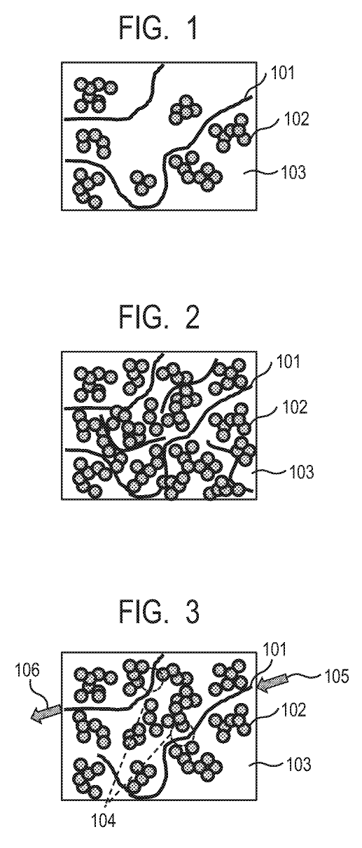

FIG. 1 is a schematic view of a resin molded article containing a thermoplastic resin 103 having blended therein carbon fibers 101 and carbon black 102. The conductivity of the molded product containing the thermoplastic resin 103 is expressed by contact between the carbon fibers 101, contact between particles of the carbon black 102, or contact between each of the carbon fibers 101 and the carbon black 102. The thermoplastic resin 103 is an insulator (about 10¹⁰ ohms per square (Ω/□) or more), and hence, when such contact is absent, the conductivity is not expressed. Therefore, in ordinary cases, in order to achieve desired conductivity, as illustrated in FIG. 2, the addition amounts of the carbon fibers 101 and the carbon black 102 need to be increased to blend large amounts of the carbon fibers 101 and the carbon black 102 into the thermoplastic resin 103.

The present inventor has focused attention on the contact between each of the carbon fibers 101 and the carbon black 102, and considered that, when the contact between the carbon fibers 101 and the contact between each of the carbon fibers 101 and the carbon black 102 can be increased, the conductivity can be improved without increasing their addition amounts.

In view of the foregoing, the present inventor has considered that, when conductivity is locally imparted to portions where there is proximity, but not contact, between the carbon fibers 101 and between each of the carbon fibers 101 and the carbon black 102, the same effect as that in the case of increasing the addition amounts of the carbon fibers 101 and the carbon black 102 is obtained.

In view of the foregoing, the present inventor has investigated a conductive agent with which the surfaces of the carbon fibers 101 and the carbon black 102 are treated, and as a result, found that, when only the carbon fibers 101 are treated with a liquid conductive agent, the same effect as that in the case of increasing the addition amounts of the carbon fibers 101 and the carbon black 102 is obtained.

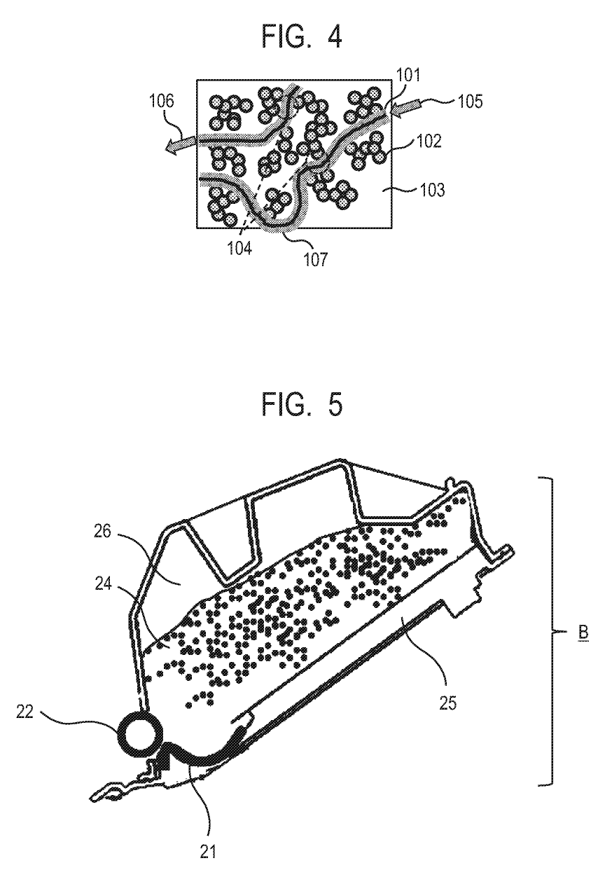

This is because under a state in which the carbon fibers 101 are not treated with a conductive liquid 107 (FIG. 3), in portions 104 where the carbon fibers 101 and the carbon black 102 are brought into proximity to each other, the carbon fibers 101 and the carbon black 102 are substantially not brought into contact with each other. Accordingly, an electric current flowing from an electric current inlet 105 cannot reach an electric current outlet 106 owing to the presence of an insulator, i.e., the thermoplastic resin 103 in the portions 104 where the carbon fibers 101 and the carbon black 102 are brought into proximity to each other, resulting in a state in which the electric current does not flow. Such resin composition has a surface resistivity of from about 10³Ω/□ to about 10⁴Ω/□. However, as illustrated in FIG. 4, when the surfaces of the carbon fibers 101 are treated with the conductive liquid 107, the conductive liquid 107 is retained on the surfaces of the carbon fibers 101 in the portions 104 where the carbon fibers 101 and the carbon black 102 are brought into proximity to each other. Accordingly, the carbon fibers 101 and the carbon black 102 are not brought into an insulated state, and hence the electric current flowing from the electric current inlet 105 can reach the electric current outlet 106.

The volume resistivity of the conductive liquid 107 is about 10⁴Ω·cm. Therefore, the surface resistivity of a resin molded article of the present invention illustrated in FIG. 4 was considered to be comparable to the surface resistivity of a resin molded article illustrated in FIG. 3, specifically from about 10³Ω/□ to about 10⁴Ω/□. Surprisingly, however, it has been found that, when the surfaces of the carbon fibers 101 are treated with the conductive liquid 107, the resin molded article of the present invention using the carbon fibers 101 has an extremely small surface resistivity of from about 10²Ω/□ to about 10^{0Ω/□.}

On the other hand, such effect is not obtained when the carbon black 102 is treated with the conductive liquid 107. The carbon black 102 generally forms a composite called a structure, in which a large number of primary particles are fused to each other, and hence even when added, the conductive liquid 107 is incorporated into a space inside the structure. Accordingly, the conductive liquid 107 is not retained on the surface of the carbon black 102, and hence cannot increase the contact between the particles of the carbon black 102 and the contact between each of the carbon fibers 101 and the carbon black 102.

Now, the thermoplastic resin, the carbon black, the conductive liquid, and the carbon fibers to be used for the resin composition of the present invention are described.

The carbon fibers to be used for the resin composition of the present invention are classified based on a difference in starting raw material into PAN-based carbon fibers using polyacrylonitrile as a raw material, and pitch-based carbon fibers using coal tar pitch or petroleum pitch as a raw material, the pitch-based carbon fibers being further classified into mesophase pitch-based carbon fibers and isotropic pitch-based carbon fibers based on the crystal state of pitch to be subjected to spinning, and the carbon fibers may be selected depending on applications.

The blending amount of the carbon fibers is 0.1 mass % or more and 5.0 mass % or less with respect to 100% of the total mass amount of the thermoplastic resin, the carbon black, and the carbon fibers coated with a conductive liquid. When the blending amount is less than 0.1 mass %, the distance between the carbon fibers, or between each of the carbon fibers and the carbon black is increased, and the gap cannot be filled with the conductive liquid. Accordingly, sufficient conductivity is not obtained. Meanwhile, when the blending amount is more than 5.0 mass %, the carbon fibers are liable to be exposed on the surface, and hence the surface roughness of a molded product of the resin composition of the present invention is aggravated.

Examples of the carbon black to be used for the resin composition of the present invention include, but not limited to, furnace black, acetylene black, thermal black, channel black, and Ketjen black.

The blending amount of the carbon black is 5.0 mass % or more and 30.0 mass % or less with respect to 100% of the total mass amount of the thermoplastic resin, the carbon black, and the carbon fibers coated with a conductive liquid. When the blending amount is less than 5.0 mass %, the distance between each of the carbon fibers and the carbon black is increased, and the gap cannot be filled with the conductive liquid. Accordingly, sufficient conductivity is not obtained. Meanwhile, while the blending amount is more than 30.0 mass %, the carbon black is liable to be exposed on the surface, and hence the surface roughness of a molded product of the resin composition of the present invention is aggravated.

The conductive liquid to be used for the resin composition of the present invention is preferably an ion conductive liquid having good workability or the like and having uniform ion conductivity.

As the ion conductive liquid having good workability or the like, there is used, for example, a mixture of a salt having ion conductivity when ionically dissociated and a solvent capable of dissolving the salt, or a substance that is ionically dissociated at a temperature of 0° C. or more and 40° C. or less, i.e., an ionic liquid.

Examples of the salt having ion conductivity when ionically dissociated include a tetraalkylammonium salt, an ammonium salt, an alkylsulfonic acid salt, an alkylbenzenesulfonic acid salt, an alkyl sulfate, and lithium perchlorate. Of those, in view of blending into the thermoplastic resin, a sulfonic acid salt of a perfluoro compound, an amide-imide of a perfluoro compound, and the like each having high heat resistance of the salt are preferred.

Examples of the sulfonic acid salt of a perfluoro compound include potassium trifluoromethanesulfonate, potassium pentafluoroethanesulfonate, potassium heptafluoropropanesulfonate, and potassium nonafluorobutanesulfonate.

Examples of the amide-imide of a perfluoro compound include potassium bis(trifluoromethanesulfonyl)imide, potassium bis(nonafluorobutanesulfonyl)imide, and potassium N,N-hexafluoropropane-1,3-disulfonylimide.

The solvent capable of dissolving the salt is not particularly limited, but is preferably polyethylene glycol. As its molecular weight increases, the polyethylene glycol becomes unable to keep a liquid state at a temperature of 0° C. or more and 40° C. or less, and hence an appropriate molecular weight is selected depending on applications. Polyethylene glycol having a molecular weight of about 600 is a liquid having a viscosity of 150 mm²/s at 25° C., and hence enables the effects of the present invention to be obtained.

Examples of the ionic liquid include tri-n-butylmethylammonium bis(trifluoromethanesulfonyl)imide, 1-propyl-3-methylimidazolium iodide, 1-ethyl-3-methylimidazolium trifluoromethanesulfonate, methyltri-n-octylammonium bis(trifluoromethanesulfonyl)imide, and 1-hexyl-3-methylimidazolium hexafluorophosphate. The ionic liquid may be selected depending on the operating temperature of the thermoplastic resin to be used.

The carbon fibers coated with a conductive liquid to be used for the resin composition of the present invention enable the effects of the present invention to be obtained as long as 50% or more and 100% or less of the surfaces of the carbon fibers are coated with a conductive liquid. When the coating ratio is less than 50%, the contact between the carbon fibers, or between each of the carbon fibers and the carbon black cannot be formed, and hence the resin composition of the present invention cannot obtain sufficient conductivity.

The thermoplastic resin to be used for the resin composition of the present invention is not particularly limited as long as the thermoplastic resin has an insulating property, and there may be used one kind or two or more kinds selected from the group consisting of a polycarbonate resin, a styrene-based resin, an acrylic resin, a vinyl chloride resin, a styrene-vinyl acetate copolymer, a vinyl chloride-vinyl acetate copolymer, polyolefin-based resins, such as polyethylene, polypropylene, and polybutadiene, polyester resins, such as polyethylene terephthalate (PET) and polybutylene terephthalate (PBT), polyvinylidene chloride, an ionomer resin, a polyurethane resin, a silicone resin, fluorine-based resins, such as a polyvinylidene fluoride (PVdF) resin and an ethylene-tetrafluoroethylene copolymer (ETFE), an ethylene-ethyl acrylate copolymer, an ethylene-vinyl alcohol copolymer, a polyamide resin, a polyimide resin, and a modified polyphenylene oxide resin, and modified resins thereof. However, the material is not limited thereto.

Various additives other than the carbon fibers and the conductive liquid may be added to the resin composition of the present invention. Examples of the various additives include various additives to be used for thermoplastic resins, such as a filler, a dispersant, an antioxidant, a weathering agent, and a decomposition inhibitor.

The filler to be added is not particularly limited. As an inorganic filler, there are given, for example, mica, glass fiber, glass sphere, cryolite, zinc oxide, titanium oxide, calcium carbonate, clays, talc, silica, wollastonite, zeolite, diatomaceous earth, silica sand, pumice powder, slate powder, alumina, alumina white, aluminum sulfate, barium sulfate, lithopone, calcium sulfate, and molybdenum disulfide, but the inorganic filler is not limited thereto.

In addition, as an organic filler, one or more kinds are appropriately selected from, for example, tetrafluoroethylene resin particles, trifluorochloroethylene resin particles, tetrafluoroethylene-hexafluoropropylene resin particles, vinyl fluoride resin particles, vinylidene fluoride resin particles, difluorodichloroethylene resin particles, and copolymers thereof, fluorocarbons, silicone rubber particles such as silicone resin particles and silicone-based compound rubber powders. Ebonite powder, ceramic, wood powder, coconut shell powder, cork powder, cellulose powder, and wood pulp, but the organic filler is not necessarily limited thereto.

In addition, a thermoplastic elastomer may be blended in the thermoplastic resin composition depending on applications. The thermoplastic elastomer is not particularly limited. Examples thereof include, but not limited to, a polystyrene-based elastomer, a polyolefin-based elastomer, a polyester-based elastomer, a polyurethane-based elastomer, a polyamide-based elastomer, and a fluoropolymer-based elastomer.

Now, a method of producing the resin composition of the present invention is described.

The resin composition of the present invention is produced by a production method including the following steps (a) and (b).

(a) A step of preparing the carbon fibers coated with a conductive liquid by mixing and stirring the carbon fibers and the conductive liquid to coat the carbon fibers with the conductive liquid

(b) A step of producing a composited resin composition by blending the thermoplastic resin, the carbon black, and the carbon fibers coated with a conductive liquid prepared in the step (a) at such a ratio that the content of the thermoplastic resin is 65 mass % or more and 94.9 mass % or less, the content of the carbon black is 5.0 mass % or more and 30 mass % or less, and the content of the carbon fibers coated with a conductive liquid is 0.1 mass % or more and 5.0 mass % or less

As a method of coating the carbon fibers with the conductive liquid in the step (a), a dipping method, a spraying method, or the like may be selected, but the method is not limited thereto.

The dipping method is a method of preparing the carbon fibers coated with a conductive liquid, involving dipping the carbon fibers in a dipping tank immediately before molding of the thermoplastic resin containing the carbon black and the carbon fibers coated with a conductive liquid. This method facilitates the control of a treatment amount in which the surfaces of the carbon fibers are treated with the conductive liquid because a change in mass in the dipping tank and a change in mass of the carbon fibers can be easily measured.

The spraying method can apply a strong pressure, and hence facilitates the impregnation of the surfaces of the carbon fibers with the conductive liquid. However, in spraying, not all of the ejected conductive liquid adheres to the surfaces of the carbon fibers, and hence the amount of the adhesion loss of the conductive liquid is more difficult to accurately measure than in the dipping method.

In order that 50% or more and 100% or less of the surfaces of the carbon fibers may be coated with the conductive liquid by the above-mentioned method, the conductive liquid is preferably used at from 1 mass % to 400 mass %, more preferably used at from 2 mass % to 300 mass % with respect to the carbon fibers.

As a method of compositing the thermoplastic resin, the carbon black, and the carbon fibers coated with a conductive liquid in the step (b), it is appropriate to melt the thermoplastic resin, add the carbon black and the carbon fibers coated with a conductive liquid thereto, and apply a sufficient shear. Examples of the application of a shear include, but not limited to, a method involving using any of various mixers, such as a twin-screw extruder, a multi-screw extruder, a kneader, and a Banbury mixer, and a method involving using any of various roll mills, such as a twin-roll mill and a triple-roll mill.

The resin composition of the present invention is blended and composited at such a ratio that the content of the thermoplastic resin is 65 mass % or more and 94.9 mass % or less, the content of the carbon black is 5.0 mass % or more and 30 mass % or less, and the content of the carbon fibers coated with a conductive liquid prepared in the step (a) is 0.1 mass % or more and 5.0 mass % or less.

As a method of obtaining the resin molded article of the present invention, there is given a method involving melting/plasticizing the resin composition of the present invention, and then discharging the molten resin to a die, a roller, or the like. Examples thereof include, but not limited to, an injection molding method involving melting the resin composition of the present invention with a screw, and then feeding the molten resin to an openable and closable die, and an extrusion molding method involving melting the resin composition of the present invention with a screw, then continuously extruding the molten resin to a roller, and taking up the extrudate.

Particularly when the resin molded article of the present invention is a conductive resin sheet, the resin molded article is produced by a production method including the following step (c) or (d).

(c) A step of subjecting the resin composition composited in the step (b) to extrusion molding

(d) A step of subjecting the resin composition composited in the step (b) to injection molding

As a method for the extrusion molding in the step (c), there is given, for example, a method involving subjecting the molten resin composition to extrusion molding so as to have a thickness of 10 μm or more and 1 mm or less in the extrusion molding method described above.

As a method for the injection molding in the step (d), there is given, for example, a method involving feeding the molten resin composition to a die having a thickness of 1 mm or less, followed by injection molding, in the injection molding method described above. In addition, the thickness of the resin composition having a sheet shape is more preferably 10 μm or more and 200 μm or less.

The resin molded article of the present invention may be used for a conductive portion for which a metal member has heretofore been used. Specifically, a metal plate used for a cartridge may be replaced with the resin molded article of the present invention. The resin molded article of the present invention may be suitably used as a capacitance-detecting member of a cartridge.

A cartridge of the present invention is described with reference to a cross-sectional schematic view illustrated in FIG. 5.

A capacitance-detecting member 21 is formed of the resin molded article of the present invention, and is integrally molded with a frame member 25. In addition, a cartridge B includes a contact member (not shown) electrically connected to the capacitance-detecting member 21. The contact member is arranged to enable electrical connection to an external device. A developer containing portion 26 is configured to contain a developer, and is fixed to the frame member 25 by welding or the like. In this example, a toner 24 is used as the developer. The cartridge B also includes a developing roller 22. The resin molded article of the present invention has high conductivity, and hence a capacitance between the capacitance-detecting member 21 formed of the resin molded article and the developing roller 22 can be accurately detected. Accordingly, a change in capacitance based on a change in amount of the toner 24 present in the developer containing portion 26 can be accurately detected.

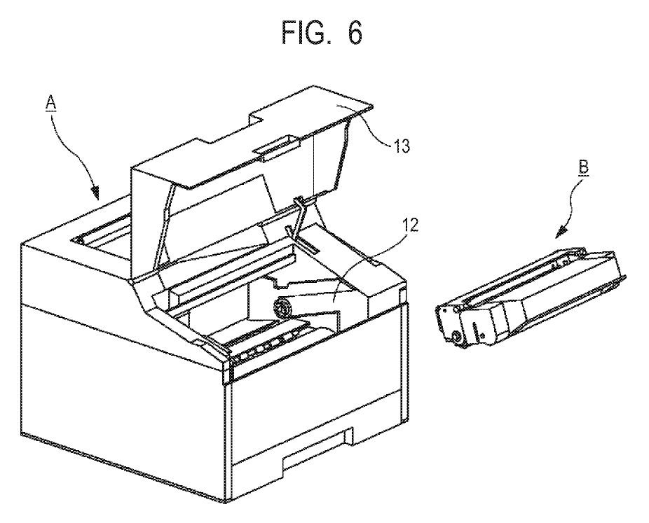

FIG. 6 is a schematic view for illustrating an image-forming apparatus according to one embodiment of the present invention. An image-forming apparatus A includes an openable and closable door 13 configured to allow the cartridge B to be mounted and removed. FIG. 6 is an illustration of a state in which the openable and closable door 13 is opened. When the cartridge B is mounted onto the image-forming apparatus A along a guide rail 12, a developer remaining amount detector (not shown) present in the image-forming apparatus A and the contact member of the cartridge B are electrically connected to each other. By adopting such configuration, the image-forming apparatus A of the present invention can accurately detect the amount of the toner 24 remaining in the cartridge B and display the amount.

Now, measurement methods for the resin composition and the resin molded article of the present invention are described.

<Measurement Method for Electrical Resistance>

With regard to an apparatus for measuring electrical resistance, Loresta model GP MCP-T610 (manufactured by Mitsubishi Chemical Analytech Co., Ltd., in conformity with JIS-K7194) is used as a resistance meter, and a tandem 4-pin probe (ASP) is used as an electrode. With regard to measurement conditions, measurement is performed at five random points with an applied voltage of 10 V, and the average of the measured values is adopted as measurement data.

In addition, a measurement environment is set to 25° C.±3° C. and a relative humidity of 55±5%.

For use as a member for conduction, a surface resistivity of 100Ω/□ or less is desired.

<Measurement Method for Surface Roughness>

A surface roughness is measured in conformity with the surface roughness standards of JIS B 0601-1994, through the use of a surface roughness measuring instrument “SE-3500” (product name, manufactured by Kosaka Laboratory Ltd.). Measurement is performed at six random sites on a sample, and the average of the measured values is adopted. In the measurement, a cut-off value is set to 0.8 mm, and an evaluation length is set to 8 mm.

For integral molding with another member, it is desired that the maximum height (Rz) of the surface roughness be 1.0 μm or less.

<Measurement Method for Coating Ratio>

As a method of confirming that the conductive liquid is present on a carbon fiber surface, it is confirmed at what ratio the conductive liquid is present at each of a resin portion and the carbon fiber surface by using Transmission Electron Microscopy (TEM) and Energy Dispersive X-ray Spectroscopy (EDX) in combination. In the present invention, analysis is performed for atoms present in the conductive liquid that are different from atoms present in the thermoplastic resin, and a presence amount ratio is calculated.

Specifically, a sample was cut at random cross-sections, and part of each of the resultant cross-sections was further cut out with a microtome or the like and observed at a magnification of 200,000 by TEM. At the same time, through the use of EDX, elemental analysis was performed at 100 random points at distances of at least 10 μm or more from the carbon fibers and the carbon black, the concentration of an element contained only in the conductive liquid was calculated, and the average (X) of the calculated values was obtained. In addition, similarly, elemental analysis was performed at 100 random points on an interface between the carbon fibers and the resin, and the concentration of the element contained only in the conductive liquid was calculated at each of the points. When the concentration was 1.3 or more times as high as the average (X), the interface at the portion was defined as being coated with a liquid conductor. In addition, the number of points coated out of the 100 measurement points was defined as a coating ratio (%).

For the molded product of the resin composition of the present invention to exhibit sufficient conductivity, it is desired that the coating ratio of the surfaces of the carbon fibers with the conductive liquid be 50% or more.

### EXAMPLES

### Example 1

<Preparation of Conductive Liquid-Coated Carbon Fibers>

DIALEAD K223HM-200μ, (C1-1) manufactured by Mitsubishi Rayon Co., Ltd. was used as carbon fibers.

Tri-n-butylmethylammonium bis(trifluoromethanesulfonyl)imide (C2-1) manufactured by Wako Pure Chemical Industries, Ltd. was used as a conductive liquid.

C1-1 and C2-1 were blended at a ratio of 50 g of the latter to 950 g of the former, and were stirred using a tumbler for 10 minutes to provide carbon fibers (C-1) having surfaces subjected to coating treatment with the conductive liquid.

<Production of Resin Composition>

EVAFLEX EV450 (A-1) manufactured by Du Pont-Mitsui Polychemicals Co., Ltd. was used as a thermoplastic resin.

A DENKA BLACK granule product (B-1) manufactured by Denki Kagaku Kogyo Kabushiki Kaisha was used as carbon black. (A-1), (B-1), and (C-1) were blended at the following ratios, and were stirred using a tumbler for 10 minutes. The resultant was kneaded using a twin-screw kneader PCM-30 manufactured by Ikegai Corp to provide a resin composition.

(A-1) 76.0 mass %

(B-1) 20.0 mass %

(C-1) 4.0 mass %

<Sheet Molding>

The resultant resin composition was subjected to extrusion molding using a sheet extruder obtained by connecting a coat hanger die having a width of 300 mm to a single-screw extruder manufactured by Research Laboratory of Plastics Technology Co., Ltd. to provide a sheet-shaped sample having a thickness of 100 μm.

<Sample Evaluation>

The surface resistivity of the resultant sheet-shaped sample was measured to be 0.86Ω/□, indicating that satisfactory conductivity was obtained. In addition, its surface roughness was measured to be 0.7 μm, indicating that satisfactory surface properties were obtained. In addition, the coating ratio of C1-1 with C2-1 was measured to be 96%.

### Example 2

A resin composition was prepared by the same method as in Example 1.

<Injection Molding>

The resultant resin composition was subjected to injection molding using an injection molding machine SE180D and a plasticizing apparatus C360 manufactured by Sumitomo Heavy Industries, Ltd. A flat plate-shaped sample measuring 150 mm×150 mm×2 mm was obtained.

<Sample Evaluation>

The surface resistivity of the resultant flat plate-shaped sample was measured to be 0.47Ω/□, indicating that satisfactory conductivity was obtained. In addition, its surface roughness was measured to be 0.5 μm, indicating that satisfactory surface properties were obtained. In addition, the coating ratio of C1-1 with C2-1 was measured to be 96%.

In each of Examples 3 to 6, a resin composition was obtained by the same method as in Example 1 except that the kinds of the materials and their ratios were changed as shown in Table 1. In Example 3, a flat plate-shaped sample was obtained from the resultant resin composition by the same method as that for the injection molding described in Example 2. In each of Examples 4 to 6, a sheet-shaped sample was obtained from the resultant resin composition by the same method as that for the extrusion molding described in Example 1. The evaluation results of the samples of Examples are shown together in Table 1.

The kinds of the materials are as described below.

Thermoplastic resin A-1: EVAFLEX EV450 manufactured by Du Pont-Mitsui Polychemicals Co., Ltd.

Thermoplastic resin A-2: HDPE F3001 manufactured by Keiyo Polyethylene Co., Ltd.

Carbon black B-1: DENKA BLACK Granule Product manufactured by Denki Kagaku Kogyo K.K.

Carbon black B-2: TOKABLACK #4400 manufactured by Tokai Carbon Co., Ltd.

Carbon fiber C1-1: DIALEAD K223SE-200 μm manufactured by Mitsubishi Rayon Co., Ltd.

Carbon fiber C1-2: DIALEAD K223Y1 manufactured by Mitsubishi Rayon Co., Ltd.

Conductive liquid C2-1:

tri-n-butylmethylammonium bis(trifluoromethanesulfonyl)imide

Conductive liquid C2-2: 1-propyl-3-methylimidazolium iodide

TABLE 1

| | | Example 1 | Example 2 | Example 3 | Example 4 | Example 5 | Example 6 |
|---|---|---|---|---|---|---|---|
| Blending amount in | A-1 | 76.0 | 76.0 | 0.00 | 65.0 | 76.00 | 94.800 |
| resin composition | A-2 | 0.0 | 0.0 | 94.89 | 0.0 | 0.00 | 0.000 |
| (mass %) | B-1 | 20.0 | 20.0 | 0.00 | 30.0 | 0.00 | 0.000 |
| | B-2 | 0.0 | 0.0 | 5.00 | 0.0 | 20.00 | 5.000 |
| | C1-1 | 3.8 | 3.8 | 0.10 | 4.5 | 0.00 | 0.000 |
| | C1-2 | 0.0 | 0.0 | 0.00 | 0.0 | 3.96 | 0.198 |
| | C2-1 | 0.2 | 0.2 | 0.01 | 0.5 | 0.00 | 0.000 |
| | C2-2 | 0.0 | 0.0 | 0.00 | 0.0 | 0.04 | 0.002 |
| Pretreatment | | C1-1 | C1-1 | C1-1 | C1-1 | C1-2 | C1-2 |
| | | C2-1 | C2-1 | C2-1 | C2-1 | C2-2 | C2-2 |
| Molding method | | Extrusion | Injection | Injection | Extrusion | Extrusion | Extrusion |
| | | molding | molding | molding | molding | molding | molding |
| Evaluation | Surface resistivity | 0.86 | 0.47 | 86 | 0.21 | 0.73 | 94 |
| | (Ω/□) | | | | | | |
| | Surface roughness | 0.6 | 0.5 | 0.3 | 0.8 | 0.7 | 0.3 |
| | Rz (μm) | | | | | | |
| | Coating ratio (%) | 96 | 96 | 100 | 100 | 54 | 58 |

### Comparative Example 1

<Preparation of Conductive Liquid-coated Carbon Fibers> in Example 1 was omitted, and all the materials were simultaneously fed to the twin-screw extruder to provide a resin composition. The resultant resin composition was subjected to extrusion molding in the same manner as in Example 1 to provide a sheet-shaped sample.

<Sample Evaluation>

The surface resistivity of the resultant sheet-shaped sample was measured to be 356Ω/□, indicating low conductivity. In addition, its surface roughness was measured to be 0.6 μm, indicating that satisfactory surface properties were obtained. In addition, the coating ratio of C1-1 with C2-1 was measured to be 5%.

### Comparative Example 2

A flat plate-shaped sample was obtained by the same method as in Example 2 except that, instead of the carbon fibers, the surface of the carbon black was subjected to the coating treatment with the conductive liquid.

<Sample Evaluation>

The surface resistivity of the resultant sample was measured to be 213Ω/□, indicating low conductivity. In addition, its surface roughness was measured to be 0.7 μm, indicating that satisfactory surface properties were obtained.

In each of Comparative Examples 3 to 7, a resin composition was obtained by the same method as in Comparative Example 1 except that the kinds of the materials, their ratios, and the pretreatment were changed as shown in Table 2. In Comparative Example 3, a flat plate-shaped sample was obtained from the resultant resin composition by the same method as that for the injection molding described in Example 2. In each of Comparative Examples 4 to 7, a sheet-shaped sample was obtained from the resultant resin composition by the same method as that for the extrusion molding described in Example 1. The evaluation results of the samples of Comparative Examples are shown together in Table 2.

TABLE 2

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Blending amount in | A-1 | 76.0 | 76.0 | 70.0 | 66.0 | 92.0 | 61.0 | 73.0 |
| resin composition | A-2 | 0.0 | 0.0 | 0.0 | 0.0 | 0.0 | 0.0 | 0.0 |
| (mass %) | B-1 | 20.0 | 20.0 | 30.0 | 30.0 | 4.0 | 35.0 | 20.0 |
| | B-2 | 0.0 | 0.0 | 0.0 | 0.0 | 0.0 | 0.0 | 0.0 |
| | C1-1 | 3.8 | 3.8 | 0.0 | 4.0 | 3.6 | 3.6 | 6.3 |
| | C1-2 | 0.0 | 0.0 | 0.0 | 0.0 | 0.0 | 0.0 | 0.0 |
| | C2-1 | 0.2 | 0.2 | 0.0 | 0.0 | 0.4 | 0.4 | 0.0 |
| | C2-2 | 0.0 | 0.0 | 0.0 | 0.0 | 0.0 | 0.0 | 0.7 |
| Pretreatment | | Omitted | B1 | — | Omitted | C1-1 | C1-1 | C1-1 |
| | | | C2-1 | | | C2-1 | C2-1 | C2-2 |
| Molding method | | Extrusion | Injection | Injection | Extrusion | Extrusion | Extrusion | Extrusion |
| | | molding | molding | molding | molding | molding | molding | molding |
| Evaluation | Surface resistivity | 356 | 213 | 862 | 721 | 4,056.00 | 0.04 | 0.26 |
| | (Ω/□) | | | | | | | |
| | Surface roughness | 0.6 | 0.7 | 0.5 | 0.8 | 0.70 | 3.8 | 4.5 |
| | Rz (μm) | | | | | | | |
| | Coating ratio (%) | 5 | — | — | — | 97 | 95 | 84 |

According to the present invention, high conductivity and high surface properties can be achieved by blending relatively small amounts of the carbon fibers and the carbon black, and hence there can be achieved a conductive resin molded article that hardly undergoes separation, peeling, or the like even when an insulating resin member, such as a housing, and a conductive member, such as wiring, are integrally molded.

In addition, when the resin molded article of the present invention is used for a conductive member for which a metal member has heretofore been used, the following effects are achieved: reductions in material cost and product assembly cost, and increases in degrees of freedom in member design and product design.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A resin composition comprising:
a thermoplastic resin;
carbon black; and
carbon fibers coated with a conductive liquid,
wherein a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less.

2. The resin composition according to claim 1, wherein a coating ratio of surfaces of the carbon fibers with the conductive liquid is 50% or more.

3. A method of producing a resin molded article comprising molding the resin composition of claim 1.

4. The method of producing a resin molded article according to claim 3, wherein the method comprises the following steps (a), (b), and (c):
(a) preparing the carbon fibers coated with a conductive liquid by coating the carbon fibers with the conductive liquid;
(b) producing a composited resin composition by blending the thermoplastic resin, the carbon black, and the carbon fibers coated with a conductive liquid prepared in the step (a) at such a ratio that a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less; and
(c) subjecting the resin composition composited in the step (b) to extrusion molding.

5. The method of producing a resin molded article according to claim 3, wherein the method comprises the following steps (a), (b), and (d):
(a) preparing the carbon fibers coated with a conductive liquid by coating the carbon fibers with the conductive liquid;
(b) producing a composited resin composition by blending the thermoplastic resin, the carbon black, and the carbon fibers coated with a conductive liquid prepared in the step (a) at such a ratio that a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less; and
(d) subjecting the resin composition composited in the step (b) to injection molding.

6. A resin molded article produced by molding a resin composition comprising:
a thermoplastic resin;
carbon black; and
carbon fibers coated with a conductive liquid,
wherein a content of the thermoplastic resin is 65 mass % or more and 94.9 mass % or less, a content of the carbon black is 5.0 mass % or more and 30 mass % or less, and a content of the carbon fibers coated with a conductive liquid is 0.1 mass % or more and 5.0 mass % or less.

7. The resin molded article according to claim 6, wherein a coating ratio of surfaces of the carbon fibers with the conductive liquid is 50% or more.

8. The resin molded article according to claim 6, wherein the resin molded article has a surface resistivity of 100Ω/□ or less and a surface roughness (Rz) of 1.0 μm or less.

9. The resin molded article according to claim 6, wherein the resin molded article has a sheet shape.

10. A cartridge comprising:
a capacitance-detecting member; and
a contact member electrically connected to the capacitance-detecting member,
wherein the capacitance-detecting member is formed of the resin molded article of claim 6.

11. An image-forming apparatus comprising a developer remaining amount detector,
wherein the developer remaining amount detector is electrically connected to the contact member of the cartridge of claim 10.
